(19) United States
(12) Patent Application Publication
(10) Pub. No.: US 2026/0073897 A1
(43) Pub. Date: Mar. 12, 2026

(54) METHOD, APPARATUS, DEVICE, AND STORAGE MEDIUM FOR TRAINING GENERATION MODEL

(71) Applicants: Beijing Zitiao Network Technology Co., Ltd., Beijing (CN); Lemon Inc., Grand Cayman (KY)

(72) Inventors: Weituo HAO, Los Angeles, CA (US); Shuo Zhang, Beijing (CN); Dongya Jia, Beijing (CN); Qingqing Huang, Los Angeles, CA (US); Jitong Chen, Los Angeles, CA (US)

(21) Appl. No.: 19/319,245

(22) Filed: Sep. 4, 2025

(30) Foreign Application Priority Data
Sep. 6, 2024 (CN) 202411252345.6

(51) Int. Cl. G10H 1/00; G06N 20/00

(52) U.S. Cl. CPC G10H 1/0025; G06N 20/00; G10H 2210/111

(57) ABSTRACT

A method, an apparatus, a device and a storage medium for training a generation model are provided. The method provided by the disclosure includes: obtaining first audio content corresponding to a first timbre and second audio content corresponding to a second timbre; processing the first audio content and the second audio content with a first generation model to generate third audio content; providing the third audio content and a first portion of the second audio content to a second generation model to generate a first audio feature; and training the second generation model based on the first audio feature and a second audio feature corresponding to the second audio content.

### CROSS REFERENCE

This application claims priority to Chinese Application No. 202411252345.6, filed on Sep. 6, 2024 and entitled “METHOD, APPARATUS, DEVICE, AND STORAGE MEDIUM FOR TRAINING GENERATION MODEL”, the entirety of which is incorporated herein by reference.

### FIELD

Example embodiments of the present disclosure generally relate to the field of computers, and in particular, to a method, an apparatus, a device, and a computer-readable storage medium for training a generation model.

### BACKGROUND

With the development of Internet and computer technologies, audio feature processing has been developed. In the field of audio feature processing, generation models have been widely concerned and used. Therefore, the generation effect of the generation model has become a major public concern.

### SUMMARY

In a first aspect of the present disclosure, a method for training a generation model is provided. The method includes: obtaining first audio content corresponding to a first timbre and second audio content corresponding to a second timbre; processing the first audio content and the second audio content with a first generation model to generate third audio content; providing the third audio content and a first portion of the second audio content to a second generation model to generate a first audio feature; and training the second generation model based on the first audio feature and the second audio feature corresponding to the second audio content.

In a second aspect of the present disclosure, an apparatus for training a generation model is provided. The apparatus includes: an obtaining module configured to obtain first audio content corresponding to a first timbre and second audio content corresponding to a second timbre; a generation module configured to process the first audio content and the second audio content with a first generation model to generate third audio content; a providing module configured to provide the third audio content and a first portion of the second audio content to a second generation model to generate a first audio feature; and a training module configured to train the second generation model based on the first audio feature and a second audio feature corresponding to the second audio content.

In a third aspect of the present disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium has a computer program stored thereon, and the computer program is executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements. In the drawings:

FIG. 1 illustrates a schematic diagram of an example environment in which embodiments according to the present disclosure may be implemented;

FIG. 2 illustrates a flowchart of a process of training a generation model according to some embodiments of the present disclosure;

FIGS. 3A-3D illustrate a flowchart of an example for training a generation model according to some embodiments of the present disclosure;

FIG. 4 illustrates a schematic structural block diagram of an example apparatus for training a generation model according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as being limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout, and any type of embodiment may be included in any section/subsection. Furthermore, the embodiments described in any section/subsection may be combined in any manner with any other embodiment described in the same section/subsection and/or different sections/subsections.

In the description of the embodiments of the present disclosure, the terms “including” and the like should be understood to mean an open-ended inclusion, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first”, “second”, and the like may refer to different or identical objects. Other explicit and implicit definitions may also be included below.

Embodiments of the present disclosure may relate to data of a user, acquisition and/or use of data, and the like. These aspects all follow the corresponding laws and regulations and related provisions. In the embodiments of the present disclosure, all data collection, acquisition, treatment, processing, forwarding, use and the like are performed on the premise that the user knows and confirms. Accordingly, when implementing the embodiments of the present disclosure, the type, the usage scope, the usage scenario, and the like of the data or information that may be involved should be notified to the user and obtain the authorization from the user in an appropriate manner according to the relevant laws and regulations. The specific notification and/or authorization manner may vary according to actual situations and application scenarios, and the scope of the disclosure is not limited in this regard.

According to the solutions in the present specification and the embodiments, for example, personal information processing is involved, processing may be performed on the premise of having a legal basis (for example, obtaining consent of a personal information subject, or necessary for performing a fulfillment contract), and processing may be performed only within a specified or agreed range. In the case that the user refuses personal information other than necessary information required by the basic function, the use of the basic function by the user will not be affected.

Embodiments of the present disclosure relate to training and inference of a model, it is understood that the data (including but not limited to the data itself, the acquisition or use of the data) involved in the training and inference process follow the requirements of the corresponding laws and regulations and related provisions.

According to a conventional solution, on one hand, the electronic device cannot accurately perform timbre conversion of a target audio. On the other hand, the traditional model cannot perform the timbre conversion of the target audio with a segment of the target audio within a predetermined time, and needs to be trained via a large amount of audio, to finally obtain the timbre-converted target audio.

Embodiments of the present disclosure provide a solution for training a generation model. According to the solution, first audio content corresponding to a first timbre and second audio content corresponding to a second timbre may be obtained; the first audio content and the second audio content are processed with a first generation model to generate third audio content; the third audio content and a first portion of the second audio content are provided to a second generation model to generate a first audio feature; and the second generation model is trained based on the first audio feature and a second audio feature corresponding to the second audio content.

According to the embodiment of the present disclosure, the second generation model is capable of being trained based on the reconstructed audio feature of the second audio content and the original audio feature of the second audio content, so that the trained second generation model has better generation effect.

Various example implementations of this solution are described in detail below in conjunction with the accompanying drawings.

### Example Environment

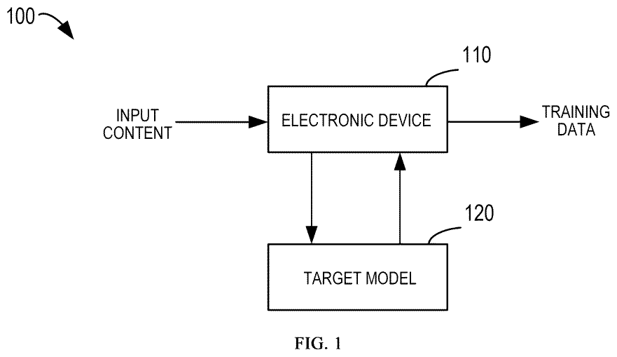

FIG. 1 illustrates a schematic diagram of an example environment 100 in which embodiments of the present disclosure may be implemented. As shown in FIG. 1, the example environment 100 may include an electronic device 110 and a target model 120.

In this example environment 100, the electronic device 110 may serve first audio content and second audio content as input content to train the target model 120 (e.g., a second generation model). In some embodiments, the electronic device 110 is at least configured to process the received input content based on the first generation model to generate third audio content. Further, the electronic device 110 may construct training data based on the third audio content and a first portion of the second audio content, and the electronic device 110 trains the target model 120 based on the obtained training data.

In some embodiments, the electronic device 110 may establish a communication connection with the target model 120. That is, the electronic device 110 may invoke a local or remote target model 120.

In some embodiments, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

It should be understood that the structures and functions of various elements in the environment 100 are described for illustrative purposes only and do not imply any limitation to the scope of the present disclosure.

### Example Process

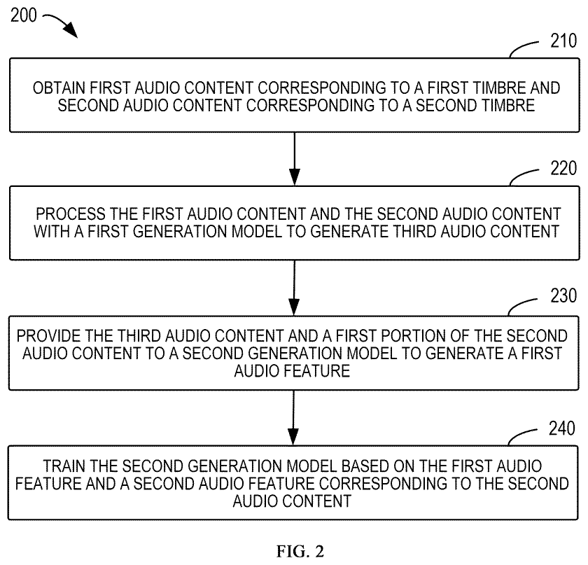

FIG. 2 illustrates a flowchart of an example process 200 of training a generation model according to some embodiments of the present disclosure. The process 200 may be implemented at the electronic device 110. The process 200 is described below with reference to FIG. 1.

As shown in FIG. 2, at block 210, the electronic device 110 obtains first audio content corresponding to a first timbre and second audio content corresponding to a second timbre.

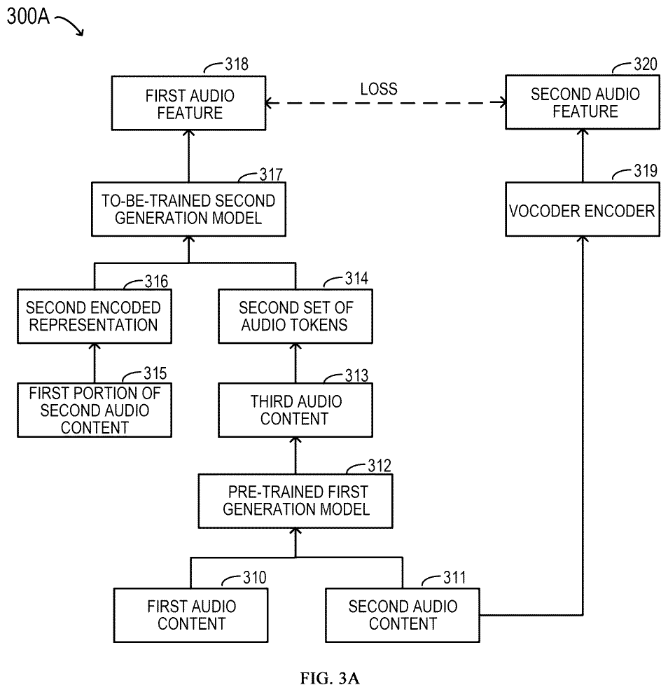

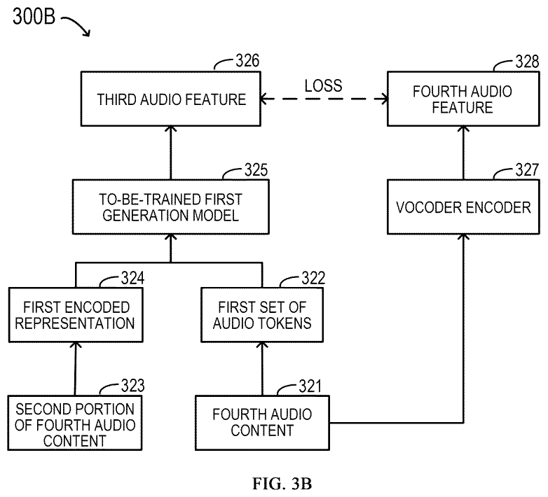

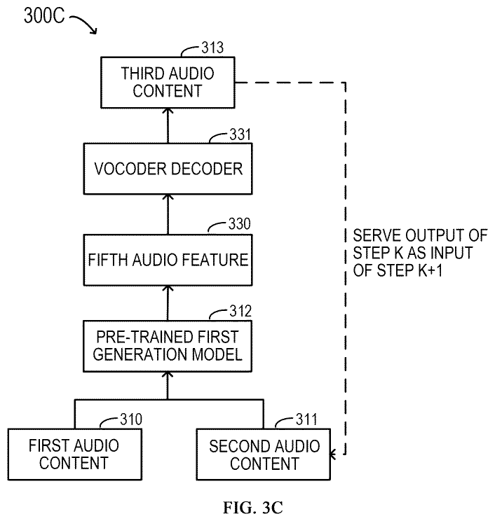

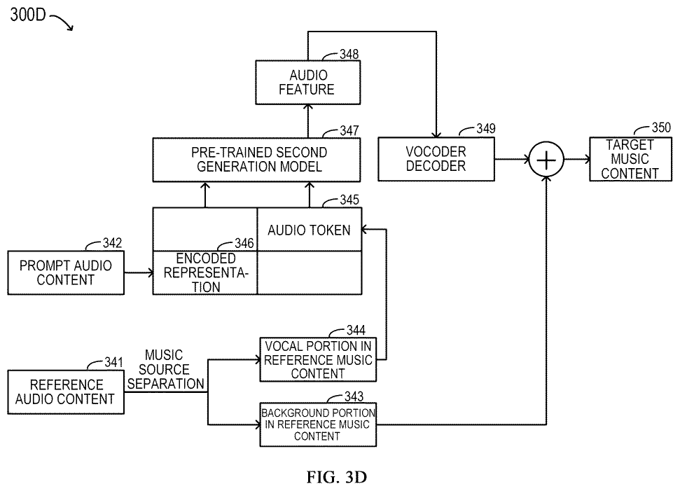

FIG. 3A illustrates a schematic diagram 300A of an example for training a generation model according to some embodiments of the present disclosure. As shown in FIG. 3A, the electronic device 110 may obtain first audio content 310 and second audio content 311. As an example, the first audio content 310 may be, for example, a song A, and the second audio content 311 may be, for example, a song B having a different timbre from that of the song A.

Referring back to FIG. 2, at block 220, the electronic device 110 processes the first audio content and the second audio content with a first generation model to generate third audio content.

In some embodiments, the first generation model may be, for example, a diffusion model.

For ease of understanding, a training process of the first generation model is described below.

Referring to FIG. 3B, the electronic device 110 may obtain fourth audio content 321, and the fourth audio content 321 may be, for example, audio content of a timbre to be converted (e.g., a song C). Further, the electronic device 110 may obtain a first set of audio tokens 322 corresponding to the fourth audio content 321 based on a tokenizer encoder (e.g., a token generator or a tokenizer).

In some embodiments, the electronic device 110 may further obtain a second portion 323 of the fourth audio content 321, and the second portion may be, for example, audio content of the fourth audio content within a predetermined time period (for example, 10 to 15 seconds). Further, the electronic device 110 may obtain a first encoded representation 324 corresponding to the second portion 323 based on a vocoder encoder (e.g., an audio encoder).

In some embodiments, the electronic device 110 may provide the obtained first set of audio tokens 322 and the first encoded representation 324 to a to-be-trained first generation model 325 for processing, to generate a third audio feature 326.

In some embodiments, the electronic device 110 may further encode the fourth audio content 321 based on a vocoder encoder 327 to obtain a fourth audio feature 328.

Further, the electronic device 110 may compare the obtained third audio feature 326 with the fourth audio feature 328 to determine a training loss, thereby training the to-be-trained first generation model 325 to be trained.

In some embodiments, a training loss may be determined, for example, based on a loss function (e.g., a cross-entropy loss function) or otherwise.

In this way, the electronic device 110 may reconstruct the audio feature of the fourth audio content 321 based on the fourth audio content 321 and the fourth audio content 323 within the predetermined time period. Further, the electronic device 110 may compare the reconstructed audio feature of the fourth audio content with the original audio feature of the fourth audio content 321, so as to more effectively train the first generation model, so that the training result of the first generation model is closer to the real effect.

For ease of understanding, the obtained first audio content 310 and the obtained second audio content 311 will be processed using the above trained first generation model.

With continued reference to FIGS. 3A and 3C, it may be understood that FIG. 3C is a detailed description of blocks 310-313 in FIG. 3A. The above contents of FIG. 3A are described below with reference to FIG. 3C.

Referring to FIG. 3C, the device 110 may process the first audio content 310 and the second audio content 311 with the pre-trained first generation model 312 to obtain a fifth audio feature 330. Further, the electronic device 110 may decode the fifth audio feature 330 based on a vocoder decoder 331 to obtain a third audio content 313. In some embodiments, a text similarity between the third audio content 313 and the second audio content 311 is greater than a first threshold. A timbre similarity between the third audio content 313 and the first audio content 310 is greater than a second threshold.

As an example, the electronic device 110 may process a song A (for example, the first audio content) and a song B (for example, the second audio content) corresponding to two different timbres based on the pre-trained first generation model 312 to obtain a reconstructed song B′ (for example, the third audio content), a timbre of the reconstructed song B′ is close to that of the song A, and its melody and lyrics are close to those of the song B.

In some embodiments, the electronic device 110 may evaluate the text similarity between the second audio content 311 and the third audio content 313 based on a word error rate. The electronic device 110 may also evaluate the timbre similarity between the first audio content 310 and the third audio content 313 based on the automated presenter verification.

In some embodiments, the electronic device 110 may take the generated result of the pre-trained first generation model 312 as a next input, so that the electronic device 110 may generate a large number of paired datasets (for example, a song B and a song B′, a song B′ and a song B″, and the like) based on the pre-trained first generation model 312.

In this way, the electronic device 110 may perform multi-round training on the second generation model based on the large number of paired datasets obtained above. Further, a timbre of the paired data generated by the electronic device 110 based on the foregoing manner is increasingly similar, so that the quality of the training data provided by the electronic device 110 to the second generation model is increasingly higher, and therefore the trained second generation model has a better generation effect.

For ease of description, a first round of training of the second generation model is taken as an example for description in the following.

Referring back to FIG. 2, at block 230, the electronic device 110 provides the third audio content and a first portion of the second audio content to the second generation model to generate the first audio feature.

In some embodiments, the second generation model may be, for example, a diffusion model.

With continued reference to FIG. 3A, the electronic device 110 may generate a second set of audio tokens 314 corresponding to the third audio content 313 (e.g., the reconstructed song B′) based on a tokenizer encoder. In some embodiments, the electronic device 110 may also obtain a first portion 315 of the second audio content 311. The first portion 315 may be, for example, a song B within a predetermined time period (e.g., 10 to 15 seconds). Further, the electronic device 110 may generate a second encoded representation 316 of the first portion 315 with a vocoder encoder.

Further, the electronic device 110 may provide the second group of audio tokens 314 and the second encoded representation 316 to a to-be-trained second generation model 317 for processing, to obtain a first audio feature 318. As an example, the first audio feature 318 may be, for example, an audio feature obtained after the timbre feature of the reconstructed song B′ is restored based on the timbre feature of the original song B.

In some embodiments, the electronic device 110 may provide the second audio content 311 to a vocoder encoder 319, and encode the second audio content 311, to obtain a second audio feature 320. As an example, the second audio feature 320 may be, for example, an audio feature of the original song B.

Referring back to FIG. 2, at block 240, the electronic device 110 trains the second generation model based on the first audio feature and the second audio feature corresponding to the second audio content.

With continued reference to FIG. 3A, the electronic device 110 may compare the obtained first audio feature 318 with the second audio feature 320 to determine a training loss, thereby training the second generation model.

In this way, the electronic device 110 may compare the audio feature of the reconstructed song B with the audio feature of the original song B, so that the trained second diffusion model has a better generation effect, and improves the accuracy of the generation result.

For ease of understanding, the timbre reconstruction process of the pre-trained second generation model will be described below.

Referring to FIG. 3D, the electronic device 110 may obtain reference audio content 341 and prompt audio content 342. As an example, the reference audio content 341 may include a full reference music content, e.g., a full song D. The prompt audio content 342 may be, for example, audio content having a particular timbre, such as humming content.

In some embodiments, the electronic device 110 may separate a background music portion 343 and a vocal portion 344 from the reference music content 341 based on a music source separation model. In this way, the electronic device 110 may ensure that the integrity of the background music portion 343 is not affected during the model processing process.

In some embodiments, the electronic device 110 may generate a set of corresponding audio tokens 345 based on the tokenizer encoder. Further, the electronic device 110 may also enable the prompt audio content 342 to generate the corresponding encoded representation 346 based on the vocoder encoder.

In some embodiments, the electronic device 110 may provide the obtained audio token 345 and the encoded representation 346 to the pre-trained second generation model 347 for processing, to obtain the corresponding audio feature 348. As an example, the audio feature 348 is a reconstructed song D′ that has a timbre close to that of the prompt audio content and a melody and lyrics that are close to those of the reference audio content (e.g., the song D). Further, the electronic device 110 may process the audio feature 348 based on a vocoder decoder 349 to generate the target audio content.

Further, the electronic device 110 may combine the target audio content with a background portion 343 of the reference music content to generate the target music content 350.

In this way, the embodiments of the present disclosure enable the second generation model to be trained based on a comparison between the audio feature of the reconstructed second audio content and the audio feature of the original second audio content, so that the trained second generation model has a better generation effect, and the accuracy of the generation result is improved.

### Example Apparatus and Device

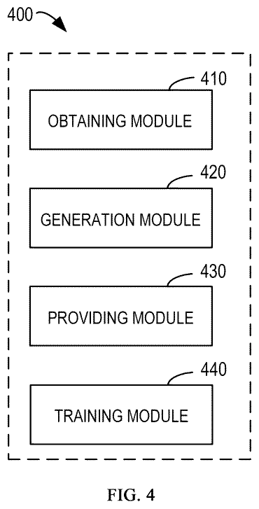

Embodiments of the present disclosure also provide a corresponding apparatus for implementing the above method or process. FIG. 4 illustrates a schematic structural block diagram of an apparatus 400 for training a generation model according to some embodiments of the present disclosure. The apparatus 400 may be implemented or included in the electronic device 110. Various modules/components in the apparatus 400 may be implemented by hardware, software, firmware, or any combination thereof.

As shown in FIG. 4, the apparatus 400 includes an obtaining module 410 configured to obtain first audio content corresponding to a first timbre and second audio content corresponding to a second timbre; a generation module 420 configured to process the first audio content and the second audio content with a first generation model to generate third audio content; a providing module 430 configured to provide the third audio content and a first portion of the second audio content to a second generation model to generate a first audio feature; and a training module 440 configured to train the second generation model based on the first audio feature and a second audio feature corresponding to the second audio content.

In some embodiments, the first generation model is trained by: providing a fourth audio content and a second portion of the fourth audio content to the first generation model to generate a third audio feature; and training the first generation model based on the third audio feature and a fourth audio feature corresponding to the fourth audio content.

In some embodiments, the first generation model is further trained by: generating a first encoded representation of the second portion with an audio encoder; generating a first set of audio tokens corresponding to the fourth audio content with a tokenizer; and providing the first encoded representation and the first set of audio tokens to the first generation model.

In some embodiments, the generation module 420 is further configured to process the first audio content and the second audio content with the first generation model to generate a fifth audio feature; and process the fifth audio feature with an audio decoder to generate the third audio content.

In some embodiments, the providing module 430 is further configured to generate a second encoded representation of the first portion with an audio encoder; generate a second set of audio tokens corresponding to the third audio content with a tokenizer; and provide the second encoded representation and the second set of audio tokens to the second generation model.

In some embodiments, a text similarity between the third audio content and the second audio content is greater than the first threshold; and/or a timbre similarity between the third audio content and the first audio content is greater than a second threshold.

In some embodiments, the apparatus 400 further includes a content generation module configured to obtain prompt audio content and reference audio content; and provide the prompt audio content and the reference audio content to the second generation model to generate target audio content.

In some embodiments, the reference audio content includes a voice portion separated from the reference music content, and the apparatus 400 further includes a content combination module configured to combine the target audio content with a background portion of the reference music content to generate target music content.

In some embodiments, the reference audio content includes full reference music content.

In some embodiments, the first generation model and/or the second generation model are diffusion models.

In some embodiments, the apparatus 400 further includes a feature generation module configured to generate the second audio feature of the second audio content with an audio encoder.

The modules included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

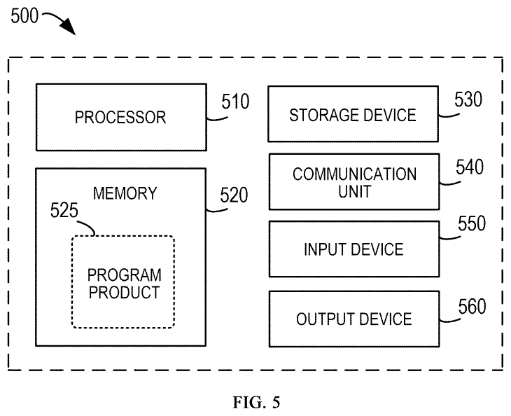

FIG. 5 illustrates a block diagram of an electronic device 500 in which one or more embodiments of the present disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in a form of a general-purpose electronic device. The components of the electronic device 500 may include, but are not limited to, one or more processors or processing units 510, a memory 520, a storage device 530, one or more communication units 540, one or more input devices 550, and one or more output devices 560. The processor 510 may be an actual or virtual processor and capable of performing various processes according to programs stored in the memory 520. In a multiprocessor system, a plurality of processors executes computer-executable instructions in parallel to improve the parallel processing capability of the electronic device 500.

The electronic device 500 generally includes a plurality of computer storage media. Such media may be any available media that is accessible by the electronic device 500, including, but not limited to, volatile and non-volatile media, removable and non-removable media. The memory 520 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 530 may be a removable or non-removable medium and may include a machine-readable medium, such as a flash drive, a magnetic disk, or any other medium, which may be capable of storing information and/or data and may be accessed within the electronic device 500.

The electronic device 500 may further include additional removable/non-removable, volatile/non-volatile storage media. Although not shown in FIG. 5, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the disclosure.

The communication unit 540 is configured to communicate with other electronic devices through a communication medium. Additionally, the functionality of components of the electronic device 500 may be implemented in a single computing cluster or multiple computing machines capable of communicating through a communication connection. Thus, the electronic device 500 may operate in a networked environment using logical connections with one or more other servers, a network profile computer (PC), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, the external device such as a storage device, a display device, etc., communicates with one or more devices that enable the user to interact with the electronic device 500, or communicates with any device (e.g., a network card, a modem, etc.) that enables the electronic device 500 to communicate with one or more other electronic devices. Such communication may be executed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, and the computer-executable instructions being executed by the processor to implement the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combinations of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in one or more blocks in the flowchart(s) and/or block diagram(s). These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on the computer, other programmable data processing apparatus, or other apparatus implement the functions/acts specified in one or more blocks in the flowchart(s) and/or block diagram(s).

The flowchart and block diagrams in the figures show an architecture, functionality, and operation that may be possibly implemented by a system, a method, and a computer program product according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagram(s) and/or flowchart(s), as well as combinations of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for training a generation model, comprising:
obtaining first audio content corresponding to a first timbre and second audio content corresponding to a second timbre;
processing the first audio content and the second audio content with a first generation model to generate third audio content;
providing the third audio content and a first portion of the second audio content to a second generation model to generate a first audio feature; and
training the second generation model based on the first audio feature and a second audio feature corresponding to the second audio content.

2. The method of claim 1, wherein the first generation model is trained by:
providing a fourth audio content and a second portion of the fourth audio content to the first generation model to generate a third audio feature; and
training the first generation model based on the third audio feature and a fourth audio feature corresponding to the fourth audio content.

3. The method of claim 2, wherein providing the fourth audio content and the second portion of the fourth audio content to the first generation model comprises:
generating a first encoded representation of the second portion with an audio encoder;
generating a first set of audio tokens corresponding to the fourth audio content with a tokenizer; and
providing the first encoded representation and the first set of audio tokens to the first generation model.

4. The method of claim 1, wherein processing the first audio content and the second audio content with the first generation model to generate third audio content comprises:
processing the first audio content and the second audio content with the first generation model to generate a fifth audio feature; and
processing the fifth audio feature with an audio decoder to generate the third audio content.

5. The method of claim 1, wherein providing the third audio content and the first portion of the second audio content to the second generation model to generate the first audio feature comprises:
generating a second encoded representation of the first portion with an audio encoder;
generating a second set of audio tokens corresponding to the third audio content with a tokenizer; and
providing the second encoded representation and the second set of audio tokens to the second generation model.

6. The method of claim 1, wherein:
a text similarity between the third audio content and the second audio content is greater than a first threshold; and/or
a timbre similarity between the third audio content and the first audio content is greater than a second threshold.

7. The method of claim 1, further comprising:
obtaining prompt audio content and reference audio content;
providing the prompt audio content and the reference audio content to the second generation model to generate target audio content.

8. The method of claim 7, wherein the reference audio content comprises a vocal portion separated from reference music content, and the method further comprises:
combining the target audio content with a background portion of the reference music content to generate target music content.

9. The method of claim 7, wherein the reference audio content comprises full reference music content.

10. The method of claim 1, wherein the first generation model and/or the second generation model are diffusion models.

11. The method of claim 1, further comprising:
generating the second audio feature of the second audio content with an audio encoder.

12. An electronic device, comprising:
at least one processor; and
at least one memory coupled to the at least one processor and storing instructions for execution by the at least one processor, the instructions, when executed by the at least one processor, causing the electronic device to perform acts comprising:
obtaining first audio content corresponding to a first timbre and second audio content corresponding to a second timbre;
processing the first audio content and the second audio content with a first generation model to generate third audio content;
providing the third audio content and a first portion of the second audio content to a second generation model to generate a first audio feature; and
training the second generation model based on the first audio feature and a second audio feature corresponding to the second audio content.

13. The electronic device of claim 12, wherein the first generation model is trained by:
providing a fourth audio content and a second portion of the fourth audio content to the first generation model to generate a third audio feature; and
training the first generation model based on the third audio feature and a fourth audio feature corresponding to the fourth audio content.

14. The electronic device of claim 13, wherein providing the fourth audio content and the second portion of the fourth audio content to the first generation model comprises:
generating a first encoded representation of the second portion with an audio encoder;
generating a first set of audio tokens corresponding to the fourth audio content with a tokenizer; and
providing the first encoded representation and the first set of audio tokens to the first generation model.

15. The electronic device of claim 12, wherein processing the first audio content and the second audio content with the first generation model to generate third audio content comprises:
processing the first audio content and the second audio content with the first generation model to generate a fifth audio feature; and
processing the fifth audio feature with an audio decoder to generate the third audio content.

16. The electronic device of claim 12, wherein providing the third audio content and the first portion of the second audio content to the second generation model to generate the first audio feature comprises:
generating a second encoded representation of the first portion with an audio encoder;
generating a second set of audio tokens corresponding to the third audio content with a tokenizer; and
providing the second encoded representation and the second set of audio tokens to the second generation model.

17. The electronic device of claim 12, wherein:
a text similarity between the third audio content and the second audio content is greater than a first threshold; and/or
a timbre similarity between the third audio content and the first audio content is greater than a second threshold.

18. The electronic device of claim 12, wherein the acts further comprise:
obtaining prompt audio content and reference audio content;
providing the prompt audio content and the reference audio content to the second generation model to generate target audio content.

19. The electronic device of claim 18, wherein the reference audio content comprises a vocal portion separated from reference music content, and the acts further comprise:
combining the target audio content with a background portion of the reference music content to generate target music content.

20. A non-transitory computer-readable storage medium having a computer program stored thereon, wherein the computer program is executable by a processor to perform acts comprising:
obtaining first audio content corresponding to a first timbre and second audio content corresponding to a second timbre;
processing the first audio content and the second audio content with a first generation model to generate third audio content;
providing the third audio content and a first portion of the second audio content to a second generation model to generate a first audio feature; and
training the second generation model based on the first audio feature and a second audio feature corresponding to the second audio content.
